(19) United States
(12) Patent Application Publication
(10) Pub. No.: US 2024/0359221 A1
(43) Pub. Date: Oct. 31, 2024

(54) MULTIPURPOSE PIPELINE SURFACE APPLICATOR

(71) Applicant: ChampionX LLC, Sugar Land, TX (US)

(72) Inventors: Saugata GON, Rosenberg, TX (US); David D. WINT, Broken Arrow, OK (US); Muhammad Hamzah KHAN, Stafford, TX (US); Sarah Nicole GROESCHEL, Houston, TX (US); Joshua Thomas HEW, Houston, TX (US); Michael Christian HAND, Chico, TX (US); Reinaldo Raafi SHABANA, Bryan, TX (US); Heath Joseph BUTTERY, Llano, TX (US)

(73) Assignee: ChampionX LLC, Sugar Land, TX (US)

(21) Appl. No.: 18/635,363

(22) Filed: Apr. 15, 2024

Related U.S. Application Data
(60) Provisional application No. 63/498,883, filed on Apr. 28, 2023.

(51) Int. Cl. B08B 9/055; F16L 55/28

(52) U.S. Cl. CPC B08B 9/0552; F16L 55/28; B08B 2209/055

(57) ABSTRACT

A pipeline pig system is adapted to clean a pipe before applying a chemical to an interior wall of the pipe. The pipeline pig system includes a cleaning pig and an applicator pig. The applicator pig is configured to follow behind the cleaning pig as the cleaning pig and applicator pig move in a lateral direction through the pipe. Examples of chemicals include one or more of a corrosion inhibitor, a biocide, a paraffin inhibitor, an asphaltene inhibitor, a surface wetting agent, a cleaning compound, an iron chelator, a solvent, a dispersant, a surfactant, an internal film forming material, and a drag reducer.

### TECHNICAL FIELD

The present disclosure generally relates to pipeline systems. More particularly, the disclosure relates to systems and methods for applying chemical treatments to interior surfaces of a pipeline.

### BACKGROUND

In-situ application of a target chemistry in a pipeline is important, particularly in view of recent advances in internal pipeline surface application/treatment systems. There are certain applications that may need uniform surface treatment of an interior surface of a pipeline with a target chemical, such as a corrosion inhibitor, a biocide, a paraffin inhibitor, a drag reducing agent, and/or a surfactant. However, various difficulties arise when attempting to apply specific target chemistries uniformly to the internal wall of a pipeline, e.g., an oil and gas production/transport line or a produced water line.

### BRIEF SUMMARY

The present disclosure provides systems and methods for applying chemical treatments to interior surfaces of a pipeline. In some embodiments, the disclosure provides a pipeline pig system adapted to clean a pipe before applying a chemical to an interior wall of the pipe. The pipeline pig system comprises a cleaning pig, which comprises a cleaning pig body arranged to extend circumferentially about an axis, and a cleaning brush coupled to the cleaning pig body and arranged to extend circumferentially around the cleaning pig body relative to the axis, wherein the cleaning brush removes residue from the interior wall of the pipe as the cleaning pig moves in a lateral direction through the pipe. The system also comprises an applicator pig spaced apart axially from the cleaning pig to define a application storage space therebetween, wherein the applicator pig moves in the lateral direction through the pipe. The applicator pig comprises an applicator pig body arranged to extend circumferentially about the axis, the applicator pig body includes a mixer in fluid communication with the application storage space between the cleaning pig and the applicator pig, wherein the applicator pig body mixes one or more chemical applications that flow from the application storage space to the mixer as the applicator pig moves in the lateral direction through the pipe to provide a target application mixture, an applicator brush coupled to the applicator pig body for movement therewith and arranged to extend circumferentially around the applicator pig body relative to the axis, wherein the applicator brush applies the target application mixture from the mixer to the interior wall of the pipe as the applicator pig moves in the lateral direction through the pipe behind the cleaning pig, and drive means for rotating the applicator pig body as it travels through the pipe, thereby causing the applicator brush to rotate and uniformly apply the target application mixture to the interior wall of the pipe.

The present disclosure also provides a method comprising providing a pipeline pig system including a cleaning pig and an applicator pig, the cleaning pig including a cleaning pig body arranged to extend circumferentially about an axis and a cleaning brush coupled to the cleaning pig body and arranged to extend circumferentially around the cleaning pig body relative to the axis, and the applicator pig including a applicator pig body arranged to extend circumferentially about the axis and an applicator brush coupled to the applicator pig body for movement therewith and arranged to extend circumferentially around the applicator pig body relative to the axis, wherein the applicator pig body includes a mixer. The method also includes inserting the cleaning pig into a pipe, adding an application material into the pipe upstream of the cleaning pig, inserting the applicator pig into the pipe upstream of the application material such that the application material is located in an application storage space defined axially between the cleaning pig and the applicator pig, applying a force to the applicator pig to cause the applicator pig and the cleaning pig to move in a lateral direction through the pipe, removing a residue from an interior wall of the pipe with the cleaning brush, transporting the application material from the application storage space to the mixer to provide a target application mixture to the applicator brush, and rotating the applicator pig about the axis to cause the applicator brush to rotate and uniformly apply the target application mixture to the interior wall of the pipe as the applicator pig moves in the lateral direction through the pipe.

The foregoing has outlined rather broadly the features and technical advantages of the present disclosure in order that the detailed description that follows may be better understood. Additional features and advantages of the disclosure will be described hereinafter that form the subject of the claims of this applicator.

### BRIEF DESCRIPTION OF THE SEVERAL VIEWS OF THE DRAWINGS

A detailed description of the invention is hereafter described with specific reference being made to the drawings in which:

FIG. 1 is a perspective view of a pipeline pig system adapted to clean a pipe before applying a surface treatment to an interior surface of the pipe, the pipeline pig system comprising a cleaning pig configured to remove residue from the interior surface of the pipe as the cleaning pig moves in a lateral direction through the pipe and an applicator pig configured to mix the coating material before applying the coating mixture to the interior surface of the pipe as the applicator pig moves with the cleaning pig in the lateral direction through the pipe so that the target application mixture is uniformly applied to the interior surface of the pipe as shown in FIG. 3B;

FIG. 2 is a side view of the pipeline pig system of FIG. 1 showing the cleaning pig and the applicator pig located in the pipe with the applicator pig spaced apart axially from the cleaning pig to define a application storage space therebetween that stores unmixed surface treatment chemical, and further showing the cleaning pig includes a cleaning pig body arranged to extend around an axis and annular cleaning brushes coupled to the cleaning pig body that engage the interior surface of the pipe to remove any residue and the applicator pig includes an applicator pig body arranged to extend around the axis, an applicator brush coupled to the applicator pig body that engages the interior surface of the pipe to apply the coating mixture, and wheel assemblies coupled to the applicator pig body to drive rotation of the applicator pig body about the axis;

FIG. 3 is side view of the pipe line pig system of FIG. 1 being inserted into the pipe showing the system further includes a mechanism configured apply a force to the applicator pig to move the cleaning pig and the applicator pig in the lateral direction through the pipe;

FIG. 3A is a cross-section view of a pipe like in FIG. 3 showing how other pig system does not apply the target application mixture evenly to the interior surface of the pipe such that application may be thicker in certain areas and/or may not cover the entire surface of the pipe;

FIG. 3B is a cross-section view of a pipe like in FIG. 3 showing how the pipeline pig system of FIG. 1 applies the target application mixture to a uniform thickness on the interior surface of the pipe;

FIG. 4 is a side view of the cleaning pig included in the pipeline pig system of FIG. 1 showing the cleaning pig body includes a cleaning pig head, a cleaning pig shaft that extends axially away from the cleaning pig head, and cleaning pig discs that each extend radially outward from and circumferentially around the cleaning pig shaft at a location spaced apart axially from the cleaning pig head to define an annular cavity therebetween, and further showing the annular cleaning brushes are coupled to the cleaning pig body in the annular cavity between the cleaning pig head and the cleaning pig discs;

FIG. 5 is a cross-section view of the cleaning pig of FIG. 4 take along line 5-5 showing the cleaning pig shaft is a stepped shaft having sections with different diameters;

FIG. 6 is an exploded view of the cleaning pig of FIG. 4 showing the cleaning pig includes two annular cleaning brushes that each include a base configured to be wrapped around the cleaning pig shaft of the cleaning pig body and a plurality of bristles that extend radially outward form the base;

FIG. 7 is a side view of the applicator pig included in the pipeline pig system of FIG. 1 showing the applicator pig body includes an applicator pig head, an applicator pig shaft that extends axially away from the applicator pig head, a rear applicator pig disc that extends radially outward from and circumferentially around the applicator pig shaft at a location spaced apart axially from the applicator pig head to define an annular cavity therebetween, and a forward applicator pig disc that extends radially outward from and circumferentially around the applicator pig shaft at a location axially between the applicator pig head and the rear applicator pig disc to divide the annular cavity into a first section between the applicator pig head and the forward applicator pig disc and a second section between the forward applicator pig disc and the rear applicator pig disc, and further showing the wheel assemblies are coupled to the applicator pig shaft in the first section of the annular cavity and the applicator brush is coupled to the applicator pig shaft of the applicator pig body in the second section of the annular cavity;

FIG. 8 is a cross-section of the applicator pig of FIG. 7 taken along line 8-8 showing the applicator pig body is formed to define a passageway that extends axially into the applicator pig head and the applicator pig shaft of the applicator pig body, the passageway having an inlet at the applicator pig head of the applicator pig body that opens into the application storage space and outlets that open into the annular cavity to provide the target application mixture to the applicator brush, and further showing the applicator pig body further includes a separate mixer located in the passageway to mix unmixed coating material that flows from the application storage space through the inlet of the passageway to the mixer as the applicator pig moves in the lateral direction through the pipe to provide the coating mixture;

FIG. 9 is an exploded view of the applicator pig of FIG. 8 showing the applicator pig includes the applicator pig body with the separate mixer, the applicator brush, and the wheel assemblies, and further showing each wheel assembly includes a wheel arm configured to be coupled to the applicator pig body, a wheel configured to be coupled to the wheel arm so that the wheel is at an angle relative to the axis and configured to rotate about a wheel axis, and a torsion spring configured to apply a bias force to the wheel arm of the wheel assembly to urge the wheel into engagement with the interior wall of the pipe; and

FIG. 10 is a perspective view of the mixer included in the applicator pig of FIG. 9 showing the mixer includes a plurality of static fins and an outer wall that extends circumferentially about the axis and surrounds the plurality of static fins.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not strictly limited to those illustrated in the drawings or described below.

Examples of methods and materials are described below, although methods and materials similar or equivalent to those described herein can be used in practice or testing of the present disclosure. All publications, patent applicators, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

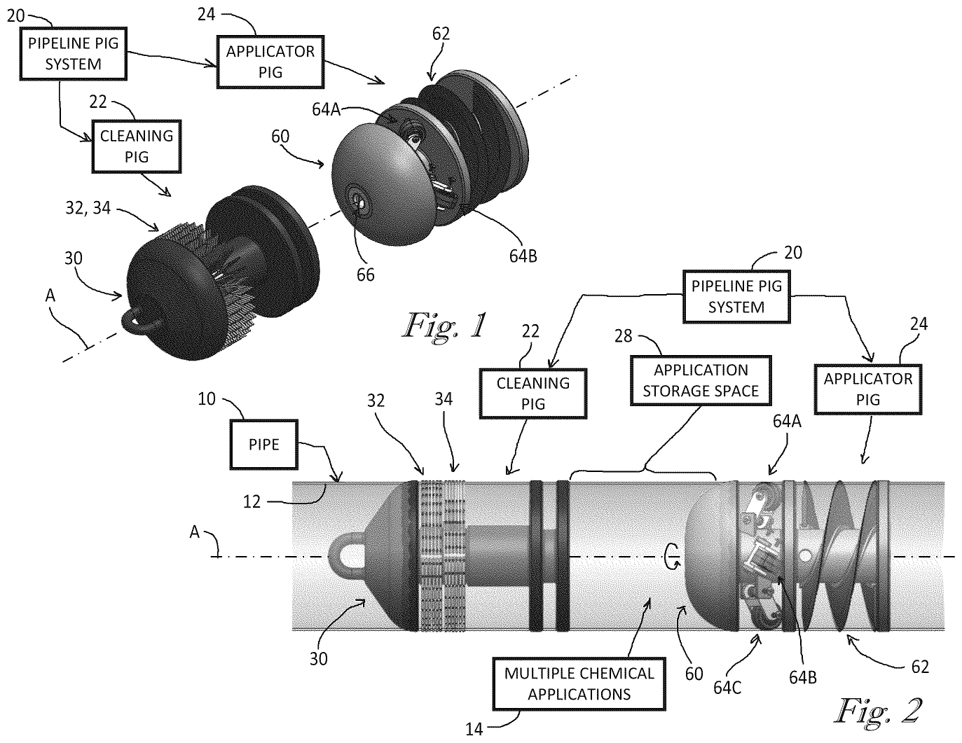

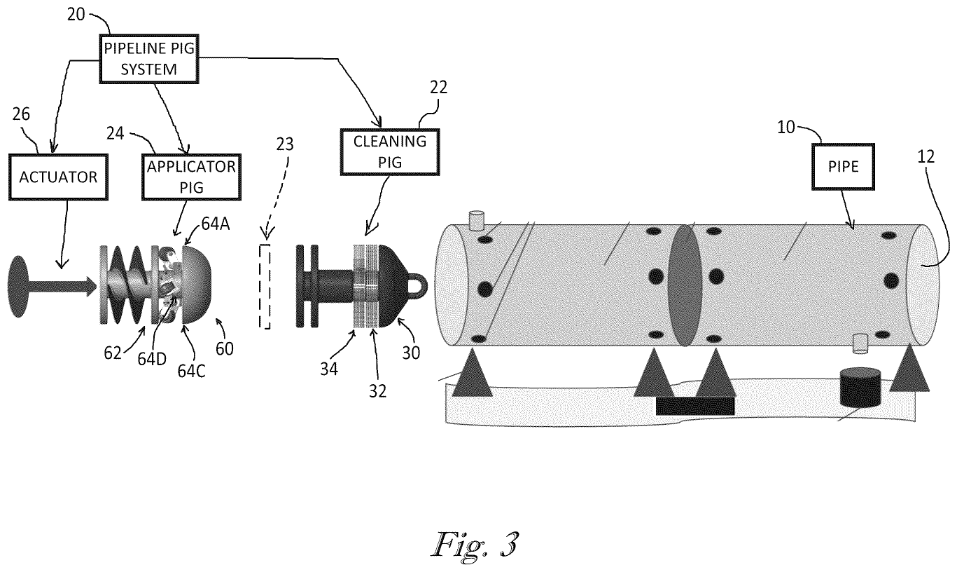

An illustrative pipeline pig system 20 adapted to clean a pipe 10 before applying a chemical application or treatment to an interior surface 12 of the pipe 10 as the system 20 moves in a lateral direction through the pipe 10 is shown in FIGS. 1 and 2. The pipeline pig system 20 includes a cleaning pig 22 and an applicator pig 24 as shown in FIGS. 1 and 2. The applicator pig 24 is spaced apart axially from the cleaning pig 22 relative to an axis A to define an application storage space 28 between the cleaning pig 22 and the applicator pig 24.

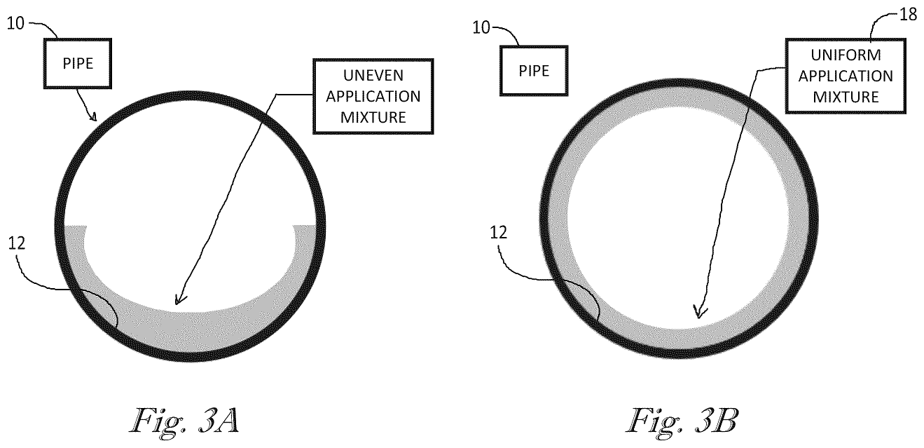

The cleaning pig 22 is configured to remove residue from the interior surface 12 of the pipe 10 as the cleaning pig 22 moves in the lateral direction through the pipe 10. This prepares the interior surface 12 of the pipe 10 before a target application mixture 18 is applied so that the target application mixture 18 may be uniformly applied onto the interior surface 12 of the pipe 10 as shown in FIG. 3B.

The applicator pig 24 follows behind the cleaning pig 22 and is configured to mix chemical application(s)/treatment(s) 14 from the application storage space 28 before applying the resulting target application mixture 18 to the interior surface 12 of the pipe 10 as the applicator pig 24 moves in the lateral direction through the pipe 10. The applicator pig 24 includes a mixer 66 in fluid communication with the application storage space 28 between the cleaning pig 22 and the applicator pig 24 that mixes the chemical application/treatment 14 to provide the target application mixture 18. The applicator pig 24 further includes drive means for rotating the applicator pig 24 as it travels through the pipe 10, thereby causing an applicator brush 62 included on the applicator pig 24 to rotate and uniformly apply the target application mixture 18 to the interior surface 12 of the pipe 10.

Pipeline pig systems may be used to apply a chemical treatment to the internal pipe wall of new and existing pipelines. However, these systems may not apply the chemicals evenly to the interior surface of the pipe as shown in FIG. 3A. In other words, the application may be thicker in certain areas and/or may not cover the entire interior surface of the pipe. Uneven application to the interior surface of the pipe may affect the flow of fluid or gas through the pipe or cause problematic zones inside the pipeline that may not be exposed to chemical treatment.

Unlike the prior art, the presently disclosed systems and methods are capable of evenly applying application materials to the interior surface/wall of a pipeline. The application material 14 to be applied with the applicator pig 24 may comprise, for example, a member selected from the group consisting of a corrosion inhibitor, a biocide, a paraffin inhibitor, an asphaltene inhibitor, a surface wetting agent, a cleaning compound, an iron chelator, a solvent, a dispersant, a surfactant, an internal film forming material, a drag reducer, and any combination thereof.

The internal film forming material may comprise, for example, a member selected from the group consisting of a liquid epoxide, an epoxy coal tar, a liquid vinyl, an acrylic copolymer emulsion, an epoxy phenolic, a target polymer, a nanomaterial/colloidal solution with specific functionality, a paint, and any combination thereof.

Illustrative, non-limiting examples of corrosion inhibitors include an imidazoline compound, a pyridinium compound, a quaternary ammonium compound, a phosphate ester-containing compound, an amine-containing compound, an amide-containing compound, a carboxylic acid-containing compound, a thiol-containing compound, and any combination thereof.

In some embodiments, suitable corrosion inhibitors include, but are not limited to, alkyl, hydroxyalkyl, alkylaryl, arylalkyl or arylamine quaternary salts; mono or polycyclic aromatic amine salts; imidazoline derivatives; mono-, di- or trialkyl or alkylaryl phosphate esters; phosphate esters of hydroxylamines; phosphate esters of polyols; and monomeric or oligomeric fatty acids.

Illustrative, non-limiting examples of biocides include chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, and any combination thereof.

Illustrative, non-limiting examples of paraffin inhibitors include paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes. Suitable dispersants include, but are not limited to, dodecyl benzene sulfonate, oxyalkylated alkylphenols, and oxyalkylated alkylpnenolic resins.

Illustrative, non-limiting examples of surface cleaners/surfactants include anionic surfactants, cationic surfactants, zwitterionic surfactants, and nonionic surfactants.

Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates.

Cationic surfactants include alkyl trimethyl quaternary ammonium salts, alkyl dimethyl benzyl quaternary ammonium salts, dialkyl dimethyl quaternary ammonium salts, and imidazolinium salts.

Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoyl polyethylene glycol esters and diesters.

Also included are betaines and sultanes, amphoteric surfactants such as alkyl amphoacetates and amphodiacetates, alkyl amphopropripionates and amphodipropionates, and alkyliminodiproprionate.

The surfactant can be a quaternary ammonium compound, an amine oxide, an ionic or non-ionic surfactant, or any combination thereof. Suitable quaternary amine compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl (2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhyexyl) dimethyl quaternary ammonium methyl sulfate.

Suitable asphaltene inhibitors include, but are not limited to, aliphatic sulphonic acids; alkyl aryl sulphonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride.

Suitable dispersants include, but are not limited to, aliphatic phosphonic acids with 2-50 carbon atoms, such as hydroxyethyl diphosphonic acid, and aminoalkyl phosphonic acids, e.g., polyaminomethylene phosphonates with 2-10 N atoms e.g., each bearing at least one methylene phosphonic acid group; examples of the latter are ethylenediamine tetra(methylene phosphonate), diethylenetriamine penta(methylene phosphonate) and the triamine- and tetramine-polymethylene phosphonates with 2-4 methylene groups between each N atom, at least 2 of the numbers of methylene groups in each phosphonate being different. Other suitable dispersants include lignin or derivatives of lignin, such as lignosulfonate and naphthalene sulfonic acid and derivatives.

Suitable solvents include, but are not limited to, an alcohol, a hydrocarbon, a ketone, an ether, an aromatic, an amide, a nitrile, a sulfoxide, an ester, water, and any combination thereof. In certain embodiments, the solvent is water, isopropanol, methanol, ethanol, 2-ethylhexanol, heavy aromatic naphtha, toluene, ethylene glycol, ethylene glycol monobutyl ether (EGMBE), diethylene glycol monoethyl ether, or xylene.

Representative polar solvents suitable for formulation with the composition include, for example, water, brine, seawater, an alcohol (including straight chain or branched aliphatic alcohols, such as methanol, ethanol, propanol, isopropanol, butanol, 2-ethylhexanol, hexanol, octanol, decanol, 2-butoxyethanol, etc.), a glycol and/or a derivative thereof (e.g., ethylene glycol, 1,2-propylene glycol, 1,3-propylene glycol, ethylene glycol monobutyl ether, etc.), a ketone (e.g., cyclohexanone, diisobutylketone), N-methylpyrrolidinone (NMP), N, N-dimethylformamide and the like.

Representative non-polar solvents suitable for formulation with the composition include an aliphatic, such as pentane, hexane, cyclohexane, methylcyclohexane, heptane, decane, dodecane, diesel, and the like; an aromatic, such as toluene, xylene, heavy aromatic naphtha, fatty acid derivatives (e.g., acids, esters, amides), and the like.

The pipeline pig system 20 includes a two pig system 20 with the ability to apply specific target chemistries uniformly to the internal pipe wall of a pipe 10, e.g., oil and gas production/transport lines or produced water lines. The two pig system 20 addresses cleaning the pipe 10 prior to application of the target application mixture 18. The lead pig, or cleaning pig 22, is configured to clean the interior surface 12 of the pipe 10 prior to treatment or application of the target application mixture 18. The trailing pig, or applicator pig 24, is configured to mix the one or more chemical applications/treatments 14 and apply the target application mixture 18 uniformly onto to the interior pipe wall 12. Additionally, the pipeline pig system 20 may provide in-situ mixing of different target chemistries to be applied to the interior surface 12 of the pipe 10.

The chemical applications/treatments 14 may also be referred to as the application material and/or a surface treatment material, and/or target chemistries. The target application mixture 18 may also be referred to as the target chemical application mixture and/or the surface treatment mixture.

The pipe 10 may be adapted to transport a fluid and/or a gas. For example, the pipe 10 may transport a hydrocarbon fluid and/or a hydrocarbon gas, optionally or alternatively including an aqueous medium, such as produced water

The cleaning pig 22 is configured to remove residue before the applicator pig 24 mixes one or more chemical applications/treatments 14 to provide the target application mixture 18 that is applied to the interior surface 12 of the pipe 10. While the application mixture 18 may be applied onto/coat the interior surface 12 of the pipe 10 as suggested in FIG. 3B, the application mixture 18 may also or alternatively be a non-coating material configured to be combined with the fluid or gas flowing through the pipe 10.

Turning again to the pipeline pig system 20, the system 20 includes the cleaning pig 22, the applicator pig 24 spaced apart axially from the cleaning pig 22 to define the application storage space 28 therebetween, and a mechanism 26 configured to push the cleaning pig 22 and the application pig 24 through the pipe 10 as shown in FIG. 3. Once both the cleaning pig 22 and the applicator pig 24 are located in the pipe 10, the mechanism 26 is configured apply a force to the applicator pig 24 to move the cleaning pig 22 and the applicator pig 24 in the lateral direction through the pipe 10.

In an illustrative embodiment, the mechanism 26 is a pressurized fluid. In an illustrative embodiment, the mechanism 26 may be a pig launcher section of the pipe 10. In some embodiments, the mechanism 26 may be a mechanical actuator. In some embodiments, the mechanism 26 may be a hydraulic actuator. In some embodiments, the mechanism, 26 may be an air compressor. In some embodiments, the mechanism 26 may be a hydraulic actuator, a positive displacement mechanism, a pressurized fluid, or any combination thereof.

In some embodiments, the pipeline pig system 20 may further include an additional spacer disc/discs 23 as suggested in FIG. 3. The spacer disc/discs 23 may be located axially between the cleaning pig 22 and the applicator pig 24. The mechanism 26 is configured to apply a force to the applicator pig 24 to the cleaning pig 22, the spacer disc/discs 23, and the applicator pig 24 in the lateral direction through the pipe 10.

The cleaning pig 22 prepares the surface of the pipe 10 by removing residue through mechanical scraping. As the applicator pig 24 travels behind the cleaning pig 22, one or more chemical applications/treatments 14 enter the applicator pig 24 through the mixer 66 and are mixed to provide the target application mixture 18 to the applicator brush 62, which uniformly applies the target application mixture 18 to the interior surface 12 of the pipe 10. The drive means 64A, 64B, 64C, 64D rotates the applicator pig 24 as the applicator pig 24 moves in the lateral direction through the pipe 10 to cause the applicator brush 62 to rotate and uniformly apply the target application mixture 18 to the interior surface 12 of the pipe 10.

The cleaning pig 22 of the pipeline pig system 20 includes a cleaning pig body 30 and a cleaning brush 32, 34 as shown in FIGS. 1-6. The cleaning pig body 30 is arranged to extend circumferentially about an axis A. The cleaning brush 32, 34 is coupled to the cleaning pig body 30. The cleaning brush 32, 34 is annular and arranged to extend circumferentially around the cleaning pig body 30 relative to the axis A. The cleaning brush 32, 34 is configured to engage the interior surface 12 of the pipe 10 to remove residue from the interior surface 12 of the pipe 10 as the cleaning pig 22 moves in the lateral direction through the pipe 10.

In an illustrative embodiment, the cleaning pig 22 includes any number of cleaning brushes 32, 34. For example, the number of cleaning brushes may vary depending on the type of surface or other factors of the pipe 10 to be cleaned. Each of the cleaning brushes 32, 34 are coupled to the cleaning pig body 30 and arranged to extend circumferentially around the cleaning pig body 30 relative to the axis A. Each of the cleaning brushes 32, 34 are spaced apart axially along the cleaning pig body 30.

In an illustrative embodiment, the cleaning pig 22 includes a first cleaning brush 32 and a second cleaning brush 34 spaced apart axially from the first cleaning brush 32 as shown in FIGS. 1-6. The first and second cleaning brushes 32, 34 are each coupled to the cleaning pig body 30. Both cleaning brushes 32, 34 are annular and arranged to extend circumferentially around the cleaning pig body 30 relative to the axis A.

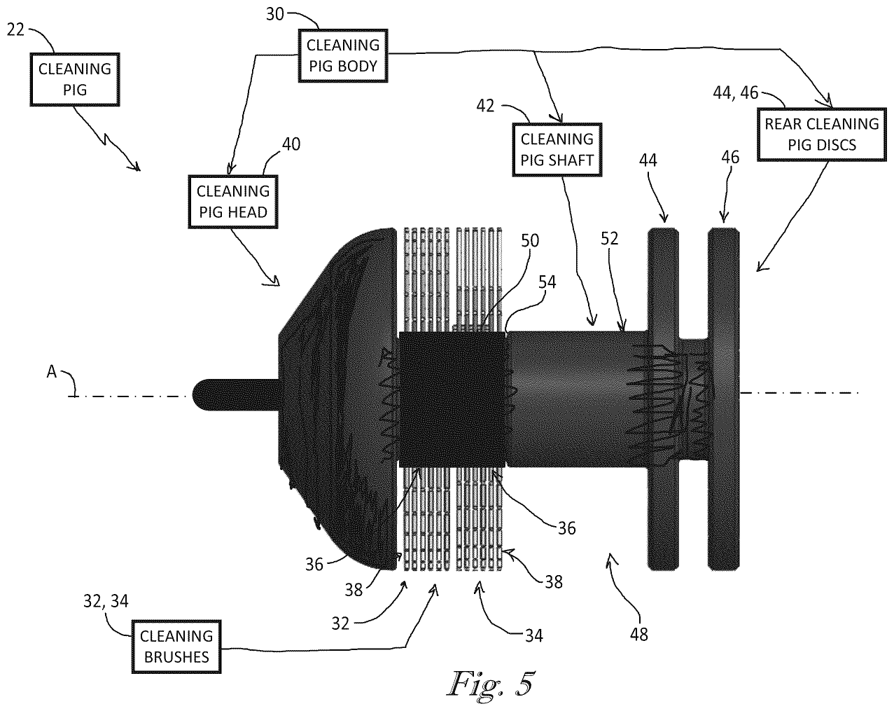

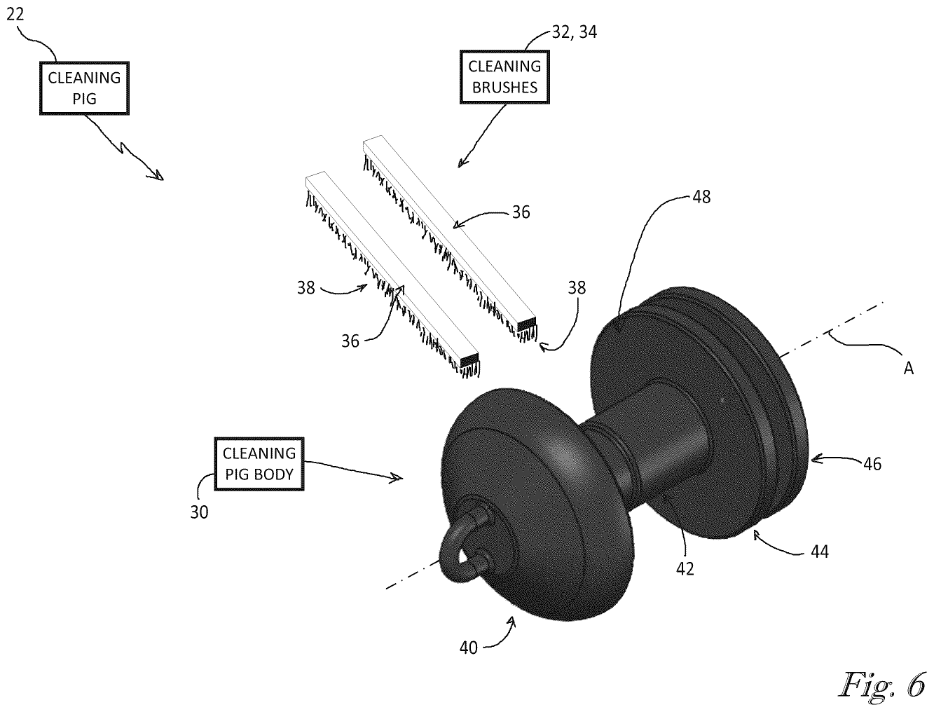

Each of the cleaning brushes 32, 34 includes a base 36 and a plurality of bristles 38 as shown in FIGS. 5 and 6. The base 36 is wrapped around the cleaning pig body 30. The plurality of bristles 38 are embedded in the base 36 and extend radially outward from the base 36.

The bristles 38 may comprise, for example, a metallic material, a plastic material, and any combination thereof. For example, the bristles 38 may comprise a metallic material, such as carbon steel, stainless steel, steel wool, or another suitable metal. Additionally, the bristles may comprise a plastic material such as Prostran® or another plastic material. Prostran refers to a polypropylene monofilament. The bristles 38 may be a flat-wire, a round-wire shape, or another suitable shape. Additionally, the bristles 38 may comprise a natural fibrous material/scrubber.

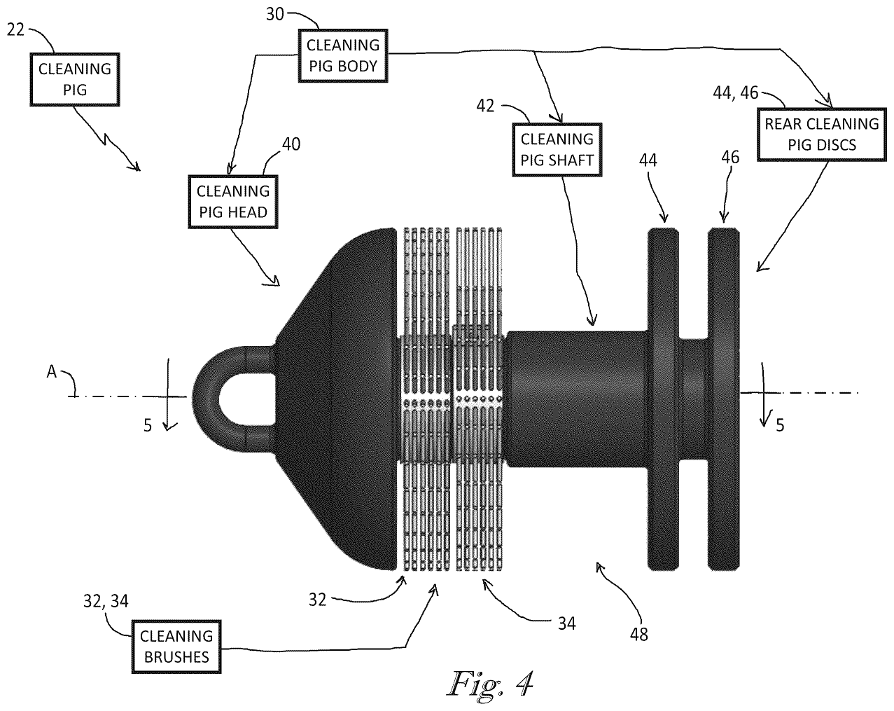

The cleaning pig body 30 includes a cleaning pig head 40, a cleaning pig shaft 42, and a rear cleaning pig disc 44, 46 as shown in FIGS. 4-6. The cleaning pig head 40 may sometimes also be referred to as a cleaning pig cup 40. The cleaning pig shaft 42 extends axially away from the cleaning pig head 40. The rear cleaning pig disc 44, 46 extends radially outward from and circumferentially around the cleaning pig shaft 42 at a location spaced apart axially from the cleaning pig head 40 to define an annular cavity 48 therebetween. Each of the cleaning brushes 32, 34 are coupled to the cleaning pig shaft 42 in the annular cavity 48 between the cleaning pig head 40 and the rear cleaning pig disc 44, 46 in an illustrative embodiment.

In an illustrative embodiment, the cleaning pig body 30 includes more than one rear cleaning pig disc 44, 46 as shown in FIGS. 4-6. Each rear cleaning pig disc 44, 46 extends radially outward from and circumferentially around the cleaning pig shaft 42.

In an illustrative embodiment, the cleaning pig body 30 includes a first rear cleaning pig disc 44 and a second rear cleaning pig disc 46 as shown in FIGS. 4-6. The second rear cleaning pig disc 46 is spaced apart axially from the first rear cleaning pig disc 44. The annular cavity 48 is defined between the cleaning pig head 40 and the first rear cleaning pig disc 44. The cleaning brushes 32, 34 are both coupled to the cleaning pig shaft 42 in the annular cavity 48 between the cleaning pig head 40 and the first cleaning pig disc 44.

The first rear cleaning pig disc 44 may have an outer diameter that is greater than or equal to an outer diameter of the second rear cleaning pig disc 46. In an illustrative embodiment, the outer diameter of the first rear cleaning pig disc 44 is greater than the second rear cleaning pig disc 46. In an illustrative embodiment, the outer diameter of the cleaning pig head 40 may be less than or equal to the outer diameter of one or both of the rear cleaning pig discs 44, 46.

In an illustrative embodiment, the cleaning pig shaft 42 is a stepped shaft as shown in FIG. 5. The cleaning pig shaft 42 has a first stepped section 50 and a second stepped section 52 that extends from the first stepped section 50. The second stepped section 52 has a greater diameter than the first stepped shaft 50 such that the cleaning pig shaft 42 has a step shoulder 54 extending between the two sections 50, 52 as shown in FIG. 5.

In an illustrative embodiment, the outer diameter of the cleaning pig 22 depends on the inner diameter of the pipe 10. The outer diameter of the cleaning pig 22 may be sized so that the cleaning pig 22 properly engages the interior surface 12 of the pipe 10.

In an illustrative embodiment, the outer diameter of the cleaning pig 22 may be greater than or equal to the inner diameter of the pipe 10. The cleaning pig 22 may comprise a flexible material so that the outer diameter of the cleaning pig 22 may be greater than the inner diameter of the pipe 10. In this way, a better seal may be formed between the cleaning pig 22 and the pipe 10 and improve the application of the target application mixture 18.

In some embodiments, the outer diameter of the cleaning pig 22 may be between about 1 inch and about 100 inches. In some embodiments, the outer diameter of the cleaning pig 22 may be between about 1 inch and about 90 inches, about 1 inch and about 80 inches, about 1 inch and about 70 inches, about 1 inch and about 60 inches, about 1 inch and about 50 inches, about 1 inch and about 40 inches, about 1 inch and about 30 inches, about 1 inch and about 20 inches, about 1 inch and about 10 inches, about 5 inches and about 100 inches, about 10 inches and about 100 inches, about 20 inches and about 100 inches, about 30 inches and about 100 inches, about 40 inches and about 100 inches, about 50 inches and about 100 inches, about 60 inches and about 100 inches, about 70 inches and about 100 inches, about 80 inches and about 100 inches, or about 90 inches and about 100 inches.

In an illustrative embodiment, the cleaning pig 22 may comprise a resin material. The resin material may be a polyurethane resin material or another suitable type of resin. The resin material may be 85A polyurethane resin. The mold used to form the cleaning pig 22 may be coated with a layer of ethyl acetate prior to molding the cleaning pig 22.

The applicator pig 24 includes an applicator pig body 60, the applicator brush 62, and the drive means 64A, 64B, 64C, 64D for rotating the applicator pig body 60 as shown in FIGS. 1-3 and 7-9. The applicator pig body 60 is arranged to extend circumferentially about the axis A. The applicator brush 62 is coupled to the applicator pig body 60 for movement therewith and arranged to extend circumferentially around the applicator pig body 60 relative to the axis A. The applicator brush 62 is configured to coat the interior surface 12 of the pipe 10 with the target application mixture 18 from the mixer 66 as the applicator pig 24 moves in the lateral direction through the pipe 10 behind the cleaning pig 22.

The applicator brush 62 comprises a member selected from the group consisting of polyurethane, nitrile, polytetrafluorethylene (PTFE), polyetheretherketone, polyvinyl chloride (PVC), high-density polyethylene (HDPE), low-density polyethylene (LDPE), polystyrene, teflon, propylene, rubber, and any combination thereof.

In an illustrative embodiment, the applicator brush 62 has a helical shape as shown FIGS. 1-3 and 7-9. The helical shape of the applicator brush 62 extends circumferentially around the applicator pig body 60 and the applicator brush 62 extends axially relative to the axis A.

In an illustrative embodiment, the drive means includes a plurality of wheel assemblies 64A, 64B, 64C, 64D as shown in FIGS. 1-3 and 7-9. Each of the wheel assemblies 64A, 64B, 64C, 64D are coupled to the applicator pig body 60 and extend from the applicator pig body 60 to the interior surface 12 of the pipe 10 once the applicator pig 24 is inserted into the pipe 10.

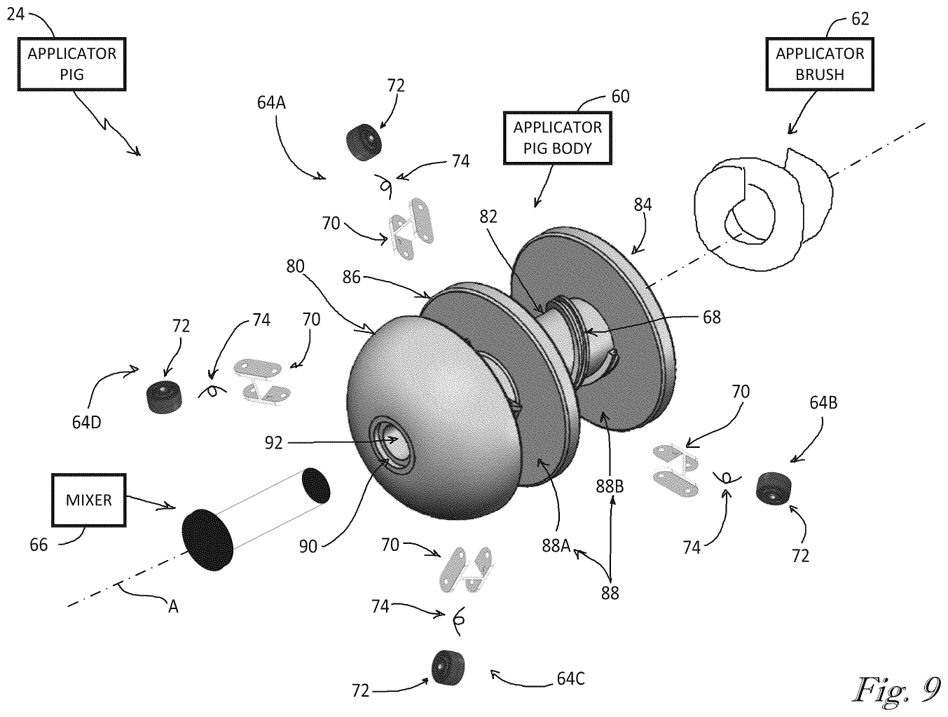

Each wheel assembly 64A, 64B, 64C, 64D has a wheel arm 70 and a wheel 72 as shown in FIG. 9. The wheel arm 70 is coupled to the applicator pig body 60. The wheel 72 is coupled to the wheel arm 70 so that the wheel 72 is at an angle relative to the axis A. The wheel 72 is configured to rotate about a wheel axis W.

In an illustrative embodiment, each of the wheel assemblies 64A, 64B, 64C, 64D includes a torsion spring 74 as shown in FIG. 9. The torsion spring 74 is configured to apply a bias force to the wheel arm 70 of the respective wheel assembly 64A, 64B, 64C, 64D to urge the wheel 72 into engagement with the interior surface 12 of the pipe 10.

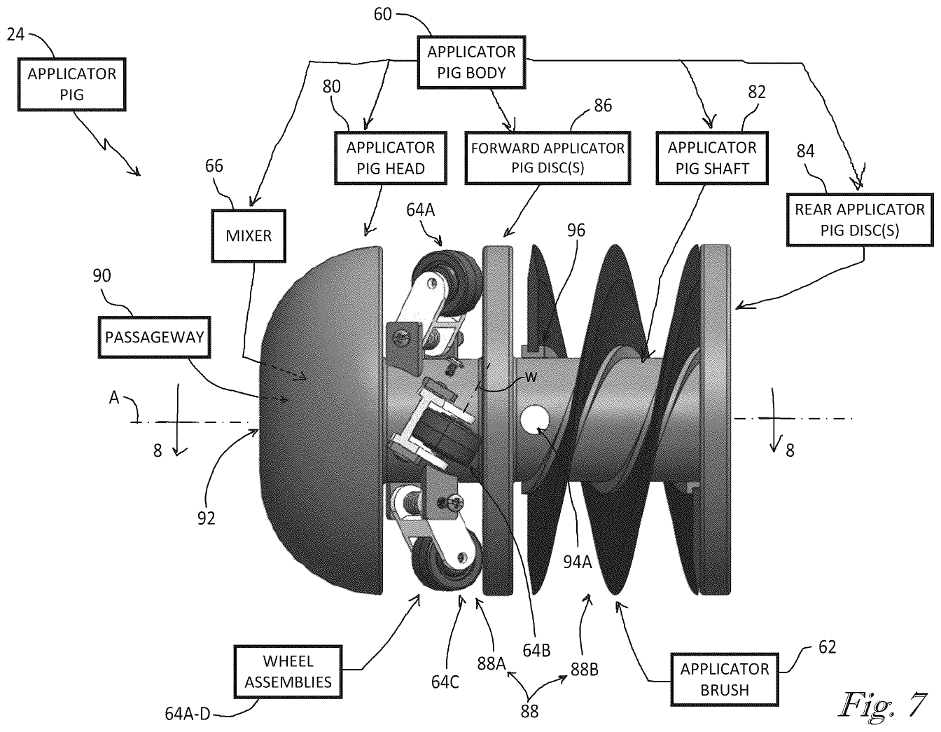

The applicator pig body 60 includes an applicator pig head 80, an applicator pig shaft 82, a rear applicator pig disc 84, and a forward applicator pig disc 86 as shown in FIGS. 7-9. The applicator pig head 80 may sometimes also be referred to as an applicator pig cup 40. The applicator pig shaft 82 extends axially away from the applicator pig head 80. The rear applicator pig disc 84 extends radially outward from and circumferentially around the applicator pig shaft 82 at a location spaced apart axially from the applicator pig head 80 to define an annular cavity 88 therebetween. The forward applicator pig disc 86 extends radially outward from and circumferentially around the applicator pig shaft 82 at a location axially between the applicator pig head 80 and the rear applicator pig disc 84 to divide the annular cavity 88 into a first section 88A and a second section 88B as shown in FIGS. 7-9.

The first section 88A of the annular cavity 88 is defined between the applicator pig head 80 and the forward applicator pig disc 86. The second section 88B of the annular cavity 88 is defined between the forward applicator pig disc 86 and the rear applicator pig disc 84.

In an illustrative embodiment, the wheel assemblies 64A, 64B, 64C, 64D are each coupled to the applicator pig shaft 82 in the first section 88A of the annular cavity 88. The applicator brush 62 is coupled to the applicator pig shaft 82 of the applicator pig body 60 in the second section 88B of the annular cavity 88.

The rear applicator pig disc 84 is behind the applicator brush 62 and configured to spread the target application mixture 18 to a uniform thickness on the interior surface 12 of the pipe 10 as shown in FIG. 3B. The forward applicator pig disc 86 is forward of the applicator brush 62 so that the target application mixture 18 is provide to the applicator brush 62 between the forward and rear applicator pig discs 84, 86.

In an illustrative embodiment, the applicator pig body 60 may include more than one rear applicator pig disc 84. Each rear applicator pig disc 84 extends radially outward from and circumferentially around the applicator pig shaft 82.

In an illustrative embodiment, the applicator pig body 60 may include more than one forward applicator pig disc 86. Each forward applicator pig disc 86 extends radially outward from and circumferentially around the applicator pig shaft 82.

The rear applicator pig disc 84 may have an outer diameter that is greater than or equal to an outer diameter of the forward applicator pig disc 86. The outer diameter of the applicator brush 62 may be greater than or equal to the outer diameter of the rear applicator pig disc 84 and/or the forward applicator pig disc 86. In an illustrative embodiment, the outer diameter of the applicator pig head 80 may be less than or equal to the outer diameter of one or both of the applicator pig discs 84, 86.

The applicator pig body 60 is formed to define a passageway 90 in fluid communication with the application storage space 28 and the second section 88B of the annular cavity 88 of the applicator pig body 60 as shown in FIGS. 7-9. The passageway 90 extends axially into the applicator pig head 80 and the applicator pig shaft 82 of the applicator pig body 60.

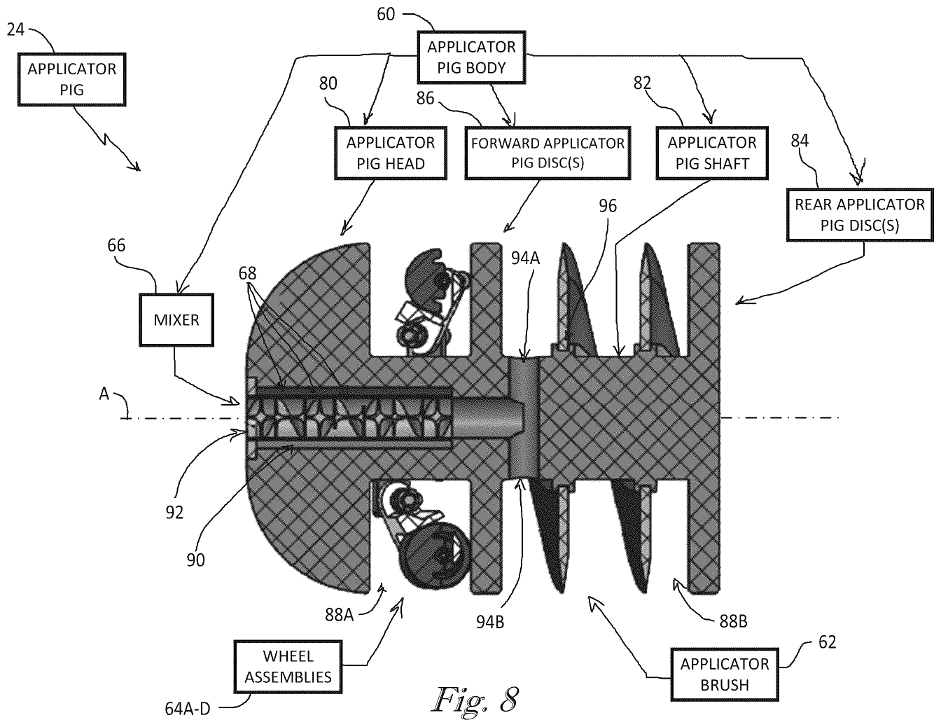

The passageway 90 has an inlet 92 and an outlet 94A, 94B as shown in FIGS. 7-9. The inlet 92 of the passageway 90 is located at the applicator pig head 80 of the applicator pig body 60 and opens into the application storage space 28. The outlet 94A, 94B opens into the annular cavity 88 to provide the target application mixture 18 to the applicator brush 62. In the illustrative embodiment, the passageway 90 has two outlets 94A, 94B as shown in FIG. 8.

In an illustrative embodiment, the mixer 66 is located in the passageway 90. The mixer 66 includes a plurality of fins 68 as shown in FIGS. 8 and 9. Each of the fins 68 extend partway about the axis A.

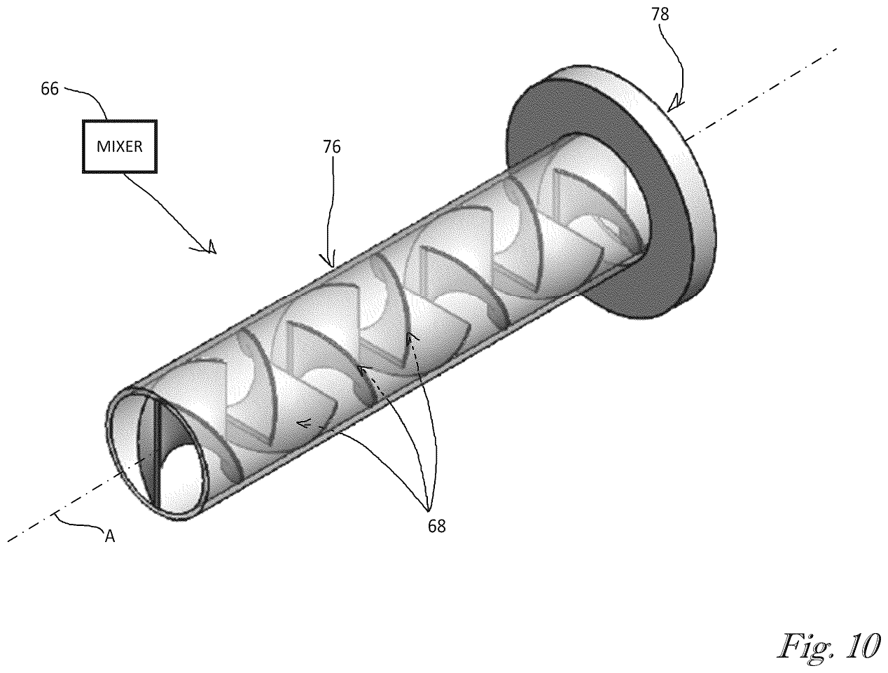

In an illustrative embodiment, the mixer 66 includes an outer wall 76 and an end wall 78 as shown in FIG. 10. The outer wall 76 extends circumferentially about the axis A and surrounds the plurality of fins 68. The end wall 78 extends radially outward from the outer wall 76. The end wall 78 engages the applicator pig head 80.

In an illustrative embodiment, the mixer 66 is a static mixer. In other words, the mixer 66 does not include any external motor to turn the plurality of fins 68 relative to the applicator pig body 60. Rather, the mixer 66 is coupled to the applicator pig body 60 for rotation therewith such that the wheel assemblies 64A, 64B, 64C, 64D rotate the mixer 66 when rotating the applicator pig body 60. This aids the mixer 66 in mixing the one or more applications/treatments 14 that flow into the mixer 66.

In some embodiments, the applicator pig body 60 may not include a separate static mixer 66 in the passageway 90. Rather, the passageway 90 formed in the applicator pig body 60 provides the mixer 66. The applicator pig body 60 mixes the application material by forcing the application material 14 to move through the passageway 90. By making the application material 14 move through the smaller passageway 90 and injecting it behind the forward applicator pig disc, the increased forced velocity through the passageway 90 ensures good mixing of the application material 14.

In an illustrative embodiment, the applicator pig shaft 82 of the applicator pig body 60 is shaped to define a helical groove 96 as shown in FIGS. 7-9. The helical groove 96 extends circumferentially around the applicator pig shaft 82. The applicator brush 62 is coupled to the applicator pig body 60 in the helical groove 96 in an illustrative embodiment. In other embodiments, the applicator brush 62 is coupled directly to an outer surface of the applicator pig shaft 82.

In an illustrative embodiment, the outer diameter of the applicator pig 24 may be greater than or equal to the inner diameter of the pipe 10. The applicator pig 24 may comprise a flexible material so that the outer diameter of the applicator pig 24 may be greater than the inner diameter of the pipe 10. In this way, a better seal may be formed between the applicator pig 24 and the pipe 10 and improve the application of the target application mixture 18.

In an illustrative embodiment, the applicator pig 24 has an outer diameter equal to the outer diameter of the cleaning pig 22. In other embodiments, the applicator pig 24 may have an outer diameter that is less than or greater than the outer diameter of the cleaning pig 22.

In some embodiments, the outer diameter of the applicator pig 24 may be between about 1 inch and about 100 inches. In some embodiments, the outer diameter of the applicator pig 24 may be between about 1 inch and about 90 inches, about 1 inch and about 80 inches, about 1 inch and about 70 inches, about 1 inch and about 60 inches, about 1 inch and about 50 inches, about 1 inch and about 40 inches, about 1 inch and about 30 inches, about 1 inch and about 20 inches, about 1 inch and about 10 inches, about 5 inches and about 100 inches, about 10 inches and about 100 inches, about 20 inches and about 100 inches, about 30 inches and about 100 inches, about 40 inches and about 100 inches, about 50 inches and about 100 inches, about 60 inches and about 100 inches, about 70 inches and about 100 inches, about 80 inches and about 100 inches, or about 90 inches and about 100 inches.

In an illustrative embodiment, the applicator pig 24 may comprise a resin material. The resin material may be different from that of the cleaning pig 22. The resin material may be a polyurethane resin material or another suitable type of resin. The resin material may be 70A polyurethane resin. The mold used to form the applicator pig 24 may be coated with a layer of ethyl acetate prior to molding the applicator pig 24.

A method of preparing a pipeline 10 for application of an even layer of the target application mixture to the interior surface 12 of the pipe 10 may include several steps. The method includes first inserting the cleaning pig 22 into the pipe 10 as suggested in FIG. 3. Then, the application material 14 is added to the pipe 10 upstream of the cleaning pig 22. In some embodiments, a spacer disc or spacer discs may be inserted into the pipe 10 before the application material 14 is added.

Next, the method includes inserting the applicator pig 24 into the pipe 10 upstream of the application material 14 such that the application material 14 is located in the application storage space 28. Once the cleaning pig 22 and the applicator pig 24 are in place, the method includes applying a force to the applicator pig 24 to cause the applicator pig 24 and the cleaning pig 22 to move in the lateral direction through the pipe 10.

As a result, the residue is removed the interior wall 12 of the pipe 10 with the cleaning brush 32, 34. The method continues with transporting the application material 14 from the application storage space 28 to the mixer 66 to provide the target application mixture 18 to the applicator brush 62. The method further includes rotating the applicator pig 24 about the axis A to cause the applicator brush 62 to rotate and uniformly apply the target application mixture 18 to the interior wall 12 of the pipe 10 as the applicator pig 24 moves in the lateral direction through the pipe 10.

The cleaning pig 22 and the applicator pig 24 may be added or removed from the pipeline 10. The pipeline 10 may have bypass sections, e.g. a pig launch and a pig receiver, in fluid communication with the main pipe 10 in order to launch and receive the cleaning and applicator pigs 22, 24. The pig launcher may be used to launch the cleaning pig 22 and the applicator pig 24 into the pipe 10, while the pig receiver may be used to receive the cleaning pig 22 and the applicator pig 24 after moving through the pipe 10.

The pig launcher may use pressurized air to displace any liquid and/or gas in the pipe 10 before the cleaning and applicator pigs 22, 24 are inserted/installed in the pipe 10. The pig launcher section may have different valves to control pressurization of the pipeline 10 when inserting the cleaning and applicator pigs 22, 24 into the pig launcher. The cleaning and applicator pigs 22, 24 may be installed through an opening in pig launcher section of the pipe 10.

The pig receiver may include a sensor configured to detect when the cleaning and applicator pigs 22, 24 arrive at the pig receiver section of the pipe 10. The pig receiver section may have different valves to control pressurization of the pipeline 10 in order to safely remove the cleaning and applicator pigs 22, 24 from the pipe 10. Once the cleaning and applicator pigs 22, 24 are removed, the valves may be reopened to return the system to the original condition.

All of the compositions, systems, and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a device” is intended to include “at least one device” or “one or more devices.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any system or composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A pipeline pig system adapted to clean a pipe before applying a chemical to an interior wall of the pipe, the pipeline pig system comprising:
a cleaning pig comprising:
a cleaning pig body arranged to extend circumferentially about an axis, and
a cleaning brush coupled to the cleaning pig body and arranged to extend circumferentially around the cleaning pig body relative to the axis, wherein the cleaning brush removes residue from the interior wall of the pipe as the cleaning pig moves in a lateral direction through the pipe,
an applicator pig spaced apart axially from the cleaning pig to define a application storage space therebetween, wherein the applicator pig moves in the lateral direction through the pipe, the applicator pig comprising:
an applicator pig body arranged to extend circumferentially about the axis, the applicator pig body includes a mixer in fluid communication with the application storage space between the cleaning pig and the applicator pig, wherein the applicator pig body mixes one or more chemical applications that flow from the application storage space to the mixer as the applicator pig moves in the lateral direction through the pipe to provide a target application mixture,
an applicator brush coupled to the applicator pig body for movement therewith and arranged to extend circumferentially around the applicator pig body relative to the axis, wherein the applicator brush applies the target application mixture from the mixer to the interior wall of the pipe as the applicator pig moves in the lateral direction through the pipe behind the cleaning pig, and
drive means for rotating the applicator pig body as it travels through the pipe, thereby causing the applicator brush to rotate and uniformly apply the target application mixture to the interior wall of the pipe.

2. The system of claim 1, wherein the drive means includes a plurality of wheel assemblies coupled to the applicator pig body that extend from the applicator pig body to the interior wall of the pipe, each wheel assembly having a wheel arm coupled to the applicator pig body and a wheel coupled to the wheel arm at an angle relative to the axis, wherein the wheel rotates about a wheel axis.

3. The system of claim 1, wherein the applicator pig body includes an applicator pig head, an applicator pig shaft that extends axially away from the applicator pig head, and a rear applicator pig disc that extends radially outward from and circumferentially around the applicator pig shaft at a location spaced apart axially from the applicator pig head to define an annular cavity therebetween, wherein the applicator brush is coupled to the applicator pig shaft of the applicator pig body in the annular cavity between the applicator pig head and the rear applicator pig disc.

4. The system of claim 3, wherein the rear applicator pig disc spreads the target application mixture to a uniform thickness on the interior wall of the pipe.

5. The system of claim 3, wherein the applicator pig body includes more than one rear applicator pig disc and each rear applicator pig disc extends radially outward from and circumferentially around the applicator pig shaft and/or wherein the applicator pig body includes more than one forward applicator pig disc and each forward applicator pig disc extends radially outward from and circumferentially around the applicator pig shaft.

6. The system of claim 3, wherein the applicator pig body further includes a forward applicator pig disc that extends radially outward from and circumferentially around the applicator pig shaft at a location axially between the applicator pig head and the rear applicator pig disc to divide the annular cavity into a first section between the applicator pig head and the forward applicator pig disc and a second section between the forward applicator pig disc and the rear applicator pig disc, wherein the drive means is coupled to the applicator pig shaft in the first section of the annular cavity and the applicator brush is coupled to the applicator pig shaft of the applicator pig body in the second section of the annular cavity.

7. The system of claim 3, wherein the applicator pig body is formed to define a passageway that extends axially into the applicator pig head and the applicator pig shaft of the applicator pig body, the passageway having an inlet at the applicator pig head of the applicator pig body that opens into the application storage space and at least one outlet that opens into the annular cavity to provide the target application mixture to the applicator brush, and wherein the mixer is located in the passageway.

8. The system of claim 3, wherein the applicator pig shaft of the applicator pig body is shaped to define a helical groove that extends circumferentially around the applicator pig shaft and the applicator brush is coupled to the applicator pig body in the helical groove.

9. The system of claim 1, wherein the applicator pig body is formed to define a passageway that extends axially into the applicator pig body, the passageway having an inlet that opens into the application storage space and at least one outlet that opens at the applicator brush.

10. The system of claim 9, wherein the mixer is located in the passageway.

11. The system of claim 1, wherein the cleaning pig body includes a cleaning pig head, a cleaning pig shaft that extends axially away from the cleaning pig head, and a rear cleaning pig disc that extends radially outward from and circumferentially around the cleaning pig shaft at a location spaced apart axially from the cleaning pig head to define an annular cavity therebetween, wherein the cleaning brush is coupled to the cleaning pig shaft of the cleaning pig body in the annular cavity between the cleaning pig head and the rear cleaning pig disc.

12. The system of claim 11, wherein the cleaning pig body includes more than one rear cleaning pig disc and each rear cleaning pig disc extends radially outward from and circumferentially around the cleaning pig shaft and/or wherein the cleaning pig includes more than one cleaning pig brush and each cleaning pig brush is coupled to the cleaning pig body and arranged to extend circumferentially around the cleaning pig body relative to the axis.

13. The system of claim 1, further comprising a mechanism that applies a force to the applicator pig to move the cleaning pig and the applicator pig in the lateral direction through the pipe.

14. The system of claim 1, wherein the one or more chemical applications comprises a member selected from the group consisting of a corrosion inhibitor, a biocide, a paraffin inhibitor, an asphaltene inhibitor, a surface wetting agent, a cleaning compound, an iron chelator, a solvent, a dispersant, a surfactant, an internal film forming material, a drag reducer, and any combination thereof.

15. A method, comprising:
providing a pipeline pig system including a cleaning pig and an applicator pig, the cleaning pig including a cleaning pig body arranged to extend circumferentially about an axis and a cleaning brush coupled to the cleaning pig body and arranged to extend circumferentially around the cleaning pig body relative to the axis, and the applicator pig including a applicator pig body arranged to extend circumferentially about the axis and an applicator brush coupled to the applicator pig body for movement therewith and arranged to extend circumferentially around the applicator pig body relative to the axis, wherein the applicator pig body includes a mixer,
inserting the cleaning pig into a pipe,
adding an application material into the pipe upstream of the cleaning pig,
inserting the applicator pig into the pipe upstream of the application material such that the application material is located in an application storage space defined axially between the cleaning pig and the applicator pig,
applying a force to the applicator pig to cause the applicator pig and the cleaning pig to move in a lateral direction through the pipe,
removing a residue from an interior wall of the pipe with the cleaning brush,
transporting the application material from the application storage space to the mixer to provide a target application mixture to the applicator brush, and
rotating the applicator pig about the axis to cause the applicator brush to rotate and uniformly apply the target application mixture to the interior wall of the pipe as the applicator pig moves in the lateral direction through the pipe.

16. The method of claim 15, wherein the applicator pig further includes a plurality of wheel assemblies coupled to the applicator pig body that extend from the applicator pig body to the interior wall of the pipe, each wheel assembly having a wheel arm coupled to the applicator pig body and a wheel coupled to the wheel arm at an angle relative to the axis, wherein the wheel rotates about a wheel axis.

17. The method of claim 15, wherein the applicator pig body includes an applicator pig head, an applicator pig shaft that extends axially away from the applicator pig head, and a rear applicator pig disc that extends radially outward from and circumferentially around the applicator pig shaft at a location spaced apart axially from the applicator pig head to define an annular cavity therebetween, wherein the applicator brush is coupled to the applicator pig shaft of the applicator pig body in the annular cavity between the applicator pig head and the rear applicator pig disc.

18. The method of claim 15, wherein the applicator pig body is formed to define passageway that extends axially into the applicator pig head and the applicator pig shaft of the applicator pig body, the passageway having an inlet at the applicator pig head of the applicator pig body that opens into the application storage space and at least one outlet that opens into the annular cavity to provide the application mixture to the applicator brush.

19. The method of claim 15, wherein the applicator pig body is formed to define a passageway that extends axially into the applicator pig body, the passageway having an inlet that opens into the application storage space and at least one outlet that opens at the applicator brush.

20. The method of claim 15, wherein the cleaning pig body includes a cleaning pig head, a cleaning pig shaft that extends axially away from the cleaning pig head, and a rear cleaning pig disc that extends radially outward from and circumferentially around the cleaning pig shaft at a location spaced apart axially from the cleaning pig head to define an annular cavity therebetween, wherein the cleaning brush is coupled to the cleaning pig shaft of the cleaning pig body in the annular cavity between the cleaning pig head and the rear cleaning pig disc.
